(19) United States
(12) Patent Application Publication
(10) Pub. No.: US 2008/0044790 A1
(43) Pub. Date: Feb. 21, 2008

(54) Ultrasonic Dental Tool

(75) Inventors: Pejman Fani, San Diego, CA (US); Mark Gersh, Los Angeles, CA (US); Brian Zargari, Los Angeles, CA (US); Christopher Quan, Houston, TX (US)

Correspondence Address: DISCUS DENTAL IMPRESSIONS, INC., 8550 HIGUERA STREET, CULVER CITY, CA, 90232, US

(73) Assignee: DISCUS DENTAL, LLC, Culver City, CA (US)

(21) Appl. No.: 11/840,922

(22) Filed: Aug. 17, 2007

Related U.S. Application Data
(60) Provisional application No. 60/838,579, filed on Aug. 17, 2006.
(60) Provisional application No. 60/838,581, filed on Aug. 17, 2006.
(60) Provisional application No. 60/838,607, filed on Aug. 17, 2006.
(60) Provisional application No. 60/838,576, filed on Aug. 17, 2006.
(60) Provisional application No. 60/946,125, filed on Jun. 25, 2007.
(60) Provisional application No. 60/945,345, filed on Jun. 20, 2007.

(51) Int. Cl. A61C 3/03

(52) U.S. Cl. 433/119

(57) ABSTRACT

The present invention relates to ultrasonic dental tools having an insert that includes monitoring mechanism(s) for usage, performance and indication mechanism(s) for replacement. The dental tool includes a dental insert having a transducer for generating ultrasonic vibrations. The ultrasonic dental insert includes a housing and a connecting body having a proximal end and a distal end having a tip attached thereto. The proximal end is attached to the transducer so as to generate the ultrasonic vibrations therefrom and to transmit the ultrasonic vibrations toward the tip attached to the distal end. In one aspect, the ultrasonic dental tool includes monitoring systems for tool usage and condition. The dental tool may include, for example, usage time monitoring circuitry, wear usage circuitry, electromagnetic monitoring circuitry and/or any other appropriate monitoring systems.

### CROSS-REFERENCE TO RELATED APPLICATIONS

This application claims the benefit of U.S. provisional application Ser. Nos. 60/838,579, filed 17 Aug. 2006, entitled “ULTRASONIC DENTAL TOOL HAVING A LIGHT SOURCE”; 60/838,581, filed 17 Aug. 2006, entitled “ULTRASONIC DENTAL TOOL HAVING A LIGHT SOURCE”; 60/838,607, field 17 Aug. 2006, entitled “ULTRASONIC DENTAL TOOL HAVING A LIGHT SOURCE; 60/838,576, filed 17 Aug. 2006, entitled “ULTRASONIC DENTAL TOOL HAVING A LIGHT SOURCE”; 60/946,125, filed 25 Jun. 2007, entitled “ULTRASONIC DENTAL TOOL”, 60/945,345, filed 20 Jun. 2007, entitled “ULTRASONIC DENTAL TOOL”; the contents of all of which are hereby incorporated by reference.

### FIELD OF THE INVENTION

The present invention relates to ultrasonic dental tools, and particularly to ultrasonic dental tools having monitoring and indicating mechanisms.

### BACKGROUND OF THE INVENTION

Dental practitioners use ultrasonic dental tools (instruments) for dental treatments and procedures, such as scaling, periodontal treatments, root canal therapy, and the like. The ultrasonic dental tools typically include a handpiece coupled at one end (i.e., a proximal end) to an electrical energy and fluid source via a cable. The cable includes a hose to provide fluid (e.g., water) and conductors to provide electrical energy.

The other end (i.e., a distal end) of the handpiece has an opening intended to receive a replaceable insert with a transducer (e.g., magnetostrictive) integral to the insert. The transducer extends from a proximal end of the insert into a hollow interior of the handpiece. An ultrasonically vibrated tip extends from a distal end of the insert.

Like most tools, ultrasonic inserts are subject to wear and are eventually replaced. This typically occurs when the insert experiences failure, such as breakage or loss of activity. Inserts are also often disposed of after a predetermined period of time. Other factors may also necessitate replacement, such as changes to power level, stroke, frequency, and/or other variations to the insert's performance. Current ultrasonic inserts do not provide clear indication on when replacement may be necessary during the course of use.

Therefore, it is desirable to provide an ultrasonic dental tool that can monitor and indicate usage, changes in insert performance and indicate when replacement is necessary.

### SUMMARY OF THE INVENTION

The present invention relates to ultrasonic dental tools having an insert that includes monitoring mechanism(s) for monitoring insert usage and performance. The present invention further relates to indication mechanism(s) for indicating timing for insert replacement.

The dental tool includes a dental insert having a transducer for generating ultrasonic vibrations, a housing and a connecting body having a proximal end and a distal end having a tip thereon. The proximal end is attached to the transducer so as to generate the ultrasonic vibrations therefrom and to transmit the ultrasonic vibrations toward the tip attached to the distal end. The ultrasonic dental insert may also include a hand grip portion.

The ultrasonic dental tool further includes an ultrasonic unit and a handpiece for providing electromagnetic energy to the transducer to generate the ultrasonic vibrations, with fluid and electrical energy being delivered to the handpiece from the unit. The handpiece includes a substantially hollow housing having a primary power source that may include a coil. The hollow housing is adapted to receive at least a portion of the insert. The handpiece is supplied with fluid and electrical energy via from an ultrasonic unit.

In one aspect, the ultrasonic dental tool includes systems for monitoring insert usage and characteristics, including but not limited to, power level, stroke amplitude, vibration frequency, and/or any other appropriate characteristics. The dental tool may include, for example, usage time monitoring circuitry, wear usage circuitry, electromagnetic monitoring circuitry and/or any other appropriate monitoring systems.

In one embodiment, the ultrasonic dental tool includes a time monitoring circuit. The time monitoring circuit may include an integrated circuit (IC) chip, which may be located on or in the insert, for recording the usage time of an ultrasonic dental insert, and an electrical signal source for supplying the IC chip with a duration signal. The duration signal may be supplied by the electrical signal source when the ultrasonic dental insert is in use. The IC chip may record the length of time the signal is on and thus may record the duration of use of an ultrasonic dental insert. The IC chip may further generate a return signal which may indicate the total recorded time. This recorded time may then be used as a suggestion to the user that a new insert may be needed. The ultrasonic unit may also include a notification or indication system for informing a user of the state of the insert, such as power level, stroke amplitude, vibration frequency, and/or any other appropriate characteristics, as noted above.

In another embodiment, the ultrasonic unit may include a time monitoring circuit which may record the duration of use of the unit. In particular, the time monitoring circuit may record the duration of a usage cycle (e.g. the time between activating the insert and deactivating the insert). The time monitoring circuit may then transmit the duration information to the IC chip on the insert, which may record an integrated time duration of the insert's usage.

In some embodiments, the IC chip may provide a predetermined maximum usage time that may limit the duration of use of the ultrasonic dental insert. The IC chip may, for example, generate a control signal which may prevent the usage of the ultrasonic dental insert by an ultrasonic unit or handpiece when the maximum usage time has been reached. In these embodiments, the IC chip may also control the activation of the unit or the unit may control activation in response to the control signal from the IC chip.

In other embodiments, the IC chip may communicate with the electrical signal source via a wireless connection. A wireless connection may include any appropriate communication system, such as, for example, radio frequency transmission (RF), infrared transmission, Bluetooth wireless, and/or any other appropriate system. An antenna may be utilized to transmit and/or receive such communications. The antenna may also be used to power the IC chip.

In general, the IC chip may be disposed on or in the ultrasonic dental insert, as noted above. The electrical signal source may in general be disposed on or in an ultrasonic dental unit or handpiece. In some embodiments, the IC chip may be connected to and communicate with the electrical signal source via electrical conductors. The insert may include, for example, electrical contact(s) that may interface with corresponding contact(s) on the handpiece. In other embodiments, the communication is effected by magnetic or physical contacts, such as, for example, actuators.

To minimize cross-talk in a dental office, such as may result from multiple inserts being in proximity, the wireless communication system may include systems to distinguish between inserts and/or provide that only one insert is recognized at a time by the electrical signal source. Examples may include, but are not limited to, limiting transmission power such that communication is only possible with an insert in very close proximity (e.g. a few centimeters), incorporating an identification and/or authentication system whereby each insert is individually identified, and/or generating an error message if more than one insert is in communication range.

In one exemplary embodiment, a control mechanism may be provided to inhibit the use of an insert on a patient after it has reached the predetermined maximum usage time. One aspect of the control mechanism is that the inhibition occurs during the attachment process of the insert to the handpiece.

One embodiment of the invention effects control of the insert usage by including a recording medium in the insert, and a signal generating device elsewhere in the ultrasonic unit. In one aspect, the invention includes receipt by the recording medium of a signal from the signal generating device and recording of a record of the recording medium corresponding to the received signal to produce a substantially permanent signal record. In another aspect of the invention, the substantially permanent signal record is read by a medium reading device and a condition of use of the particular insert containing the recording medium is ascertained. Based on the condition of use indicated by the record, as read, a control device external to the insert serves to allow or inhibit activation of the unit, handpiece or insert.

In one embodiment of the invention, the signal generating and record reading devices may be located within the handpiece. In another embodiment of the invention, one or more of the signal generating and record reading devices are located external to the handpiece.

In one embodiment of the invention, the signal from the signal generating source may be received at the recording medium by way of an electromechanical coupling. In another embodiment of the invention, the signal from the signal generating source may be received at the recording medium by way of an optical communication channel. In a still further embodiment of the invention, the signal from the signal generating source is received at the recording medium by way of a mechanical communication channel, an acoustic communication channel, a radiofrequency communication channel, or any other communication medium appropriate the particular invention embodiment.

In another exemplary embodiment, a control mechanism may be provided to inhibit the use of an insert when the insert does not have an identification marker that is recognized by the unit and/or handpiece. One aspect of the control mechanism is that the inhibition occurs during the attachment process of the insert to the handpiece. In one embodiment, the control mechanism inhibits the operation of the unit. In another embodiment, the control mechanism inhibits the operation of the handpiece.

According to one embodiment, the unit and/or handpiece may be programmed to recognize or operate an inert having a particular identification marker. According to another embodiment, the unit and/or handpiece may include a chip that activates an insert only if certain features are on the insert. Such markers may be incorporated into the chip or be a part for completing an electrical circuit so that without it, the circuit remains open. In general, these markers may not be removable once incorporated.

In another aspect, the ultrasonic dental tool includes a mechanism(s) for monitoring electromechanical characteristics of the ultrasonic dental insert. The monitoring mechanism may include, for example, sensor(s) which may detect electromechanical characteristics of the insert. Measured electromechanical characteristics may include, but are not limited to, power level, stroke amplitude, vibration frequency, and/or any other appropriate characteristic. The monitoring mechanism may be disposed on or in the ultrasonic dental insert or in the ultrasonic unit.

In one embodiment, the ultrasonic dental unit may include systems for storing established reference values for insert electromechanical characteristics and comparing these reference values to the detected values from the insert, either a new insert or after the insert has been in use. The unit may then determine whether the insert is performing within or outside a predetermined acceptable range of performance.

In another embodiment, a monitoring system may include an energy dissipating system. IC chips may be subject to overpowering and/or electric shorting from an excess of electric current. This may be particularly problematic in systems such as IC chips that are wirelessly powered by antennas and/or coils. An energy dissipating system may be included to consume at least a portion of the electric current that is provided to a monitoring system. This may aid in preventing overpowering and/or shorting of components of the monitoring system, such as, for example, an IC chip. An energy dissipating system may include, but is not limited to, resistors, inductors, capacitors, combinations thereof, and/or any other appropriate system.

In still another embodiment, the insert includes a light source. The light source may share a power source with a monitoring system and may further act as an energy dissipating system by consuming electric current and converting the energy into light. The light source may in general be disposed to direct light to the field of work.

The present invention together with the above and other advantages may best be understood from the following detailed description of the embodiments of the invention illustrated in the drawings.

### BRIEF DESCRIPTION OF THE FIGURES

FIG. 1 illustrates an ultrasonic dental tool in one embodiment of the present invention;

FIG. 1a illustrates an ultrasonic dental insert;

FIG. 2 illustrates an ultrasonic dental insert with a monitoring circuit;

FIG. 2a illustrates wired communication between an insert monitoring circuit and system on a dental unit;

FIG. 2b illustrates wireless communication between an insert monitoring circuit and system on a dental unit;

FIG. 3 illustrates an example of a coil connected to a monitoring circuit;

FIG. 4 illustrates an ultrasonic dental insert with a light source;

FIG. 5 is a block diagram of an embodiment of an ultrasonic unit control system of the ultrasonic dental tool of the present invention;

FIG. 6 is a flow chart showing one embodiment of the start process of an ultrasonic unit that is executed by the control system illustrated in FIG. 5;

FIG. 7 is a flow chart showing an embodiment of the monitoring process of an ultrasonic dental tool that is executed by the control system illustrated in FIG. 5.

FIG. 8 is a cross-sectional view of a dental tool insert having a light source;

FIGS. 9 and 9A illustrate the inclusion of a light source, a transducer and magnetic elements to a portion of the dental tool insert;

FIG. 10 is an exploded perspective view of the dental tool insert of FIG. 2;

FIG. 11 illustrates an embodiment of an ultrasonic dental insert with an integral sheath;

FIG. 12 shows a partial see-through perspective view of an insert with an integral sheath, illumination energy coil and a light source inserted into a handpiece;

### DETAILED DESCRIPTION OF THE INVENTION

The detailed description set forth below is intended as a description of the presently exemplified device provided in accordance with aspects of the present invention and is not intended to represent the only forms in which the present invention may be practiced or utilized. It is to be understood, however, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention relates to ultrasonic dental tools, and particularly to ultrasonic dental tools having monitoring and indicating mechanisms. In addition, the present invention also relates to ultrasonic dental tools, and particularly to ultrasonic dental tools having control mechanisms for controlling the activation of the unit, handpiece and/or insert.

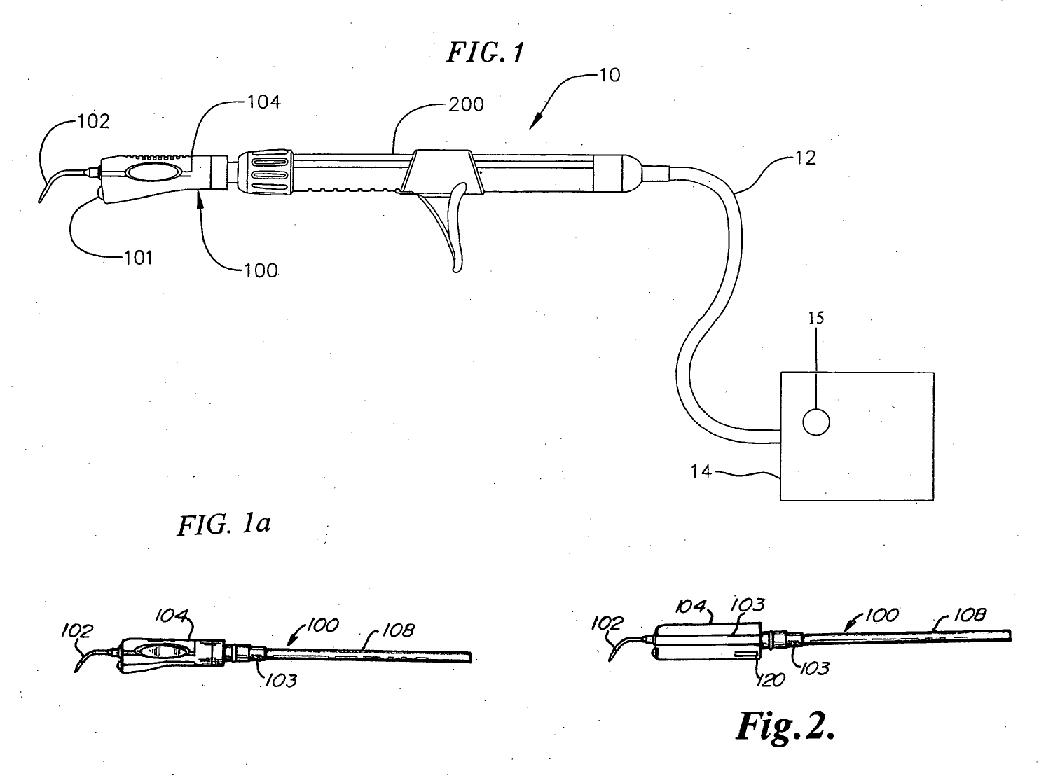

Referring to FIG. 1, an ultrasonic dental tool 10 in general includes an ultrasonic dental insert 100, a handpiece 200 and an ultrasonic unit 14. The insert 100 generally includes a connecting body 103 having a proximal end and a distal end having a tool tip 102 attached thereto, a housing 104 and a transducer 108 for generating ultrasonic vibrations, as shown in FIG. 1a. The proximal end of the connecting body 103 is attached to the transducer 108 such that the ultrasonic vibrations are transmitted toward the tool tip 102 at the distal end. The tool tip 102 and the connecting body 103 may be separate components joined together to transmit ultrasonic vibrations from the transducer 108, or they may be formed as a unitary component. The tool tip 102 may be attached to the distal end or integral to the distal end of the connecting body.

The ultrasonic dental insert 100 is generally inserted into a handpiece 200 for providing electromagnetic energy to the transducer 108 to generate the ultrasonic vibrations. The handpiece 200 includes a substantially hollow housing having a primary power source that may include a coil. The handpiece 200 is supplied with fluid and electrical energy via a cable 12 from the ultrasonic unit 14.

In one aspect, the ultrasonic dental tool 10 includes monitoring systems for tool usage and condition. The dental tool 10 may include, for example, usage time monitoring circuitry, wear usage circuitry, electromagnetic monitoring circuitry and/or any other appropriate monitoring systems.

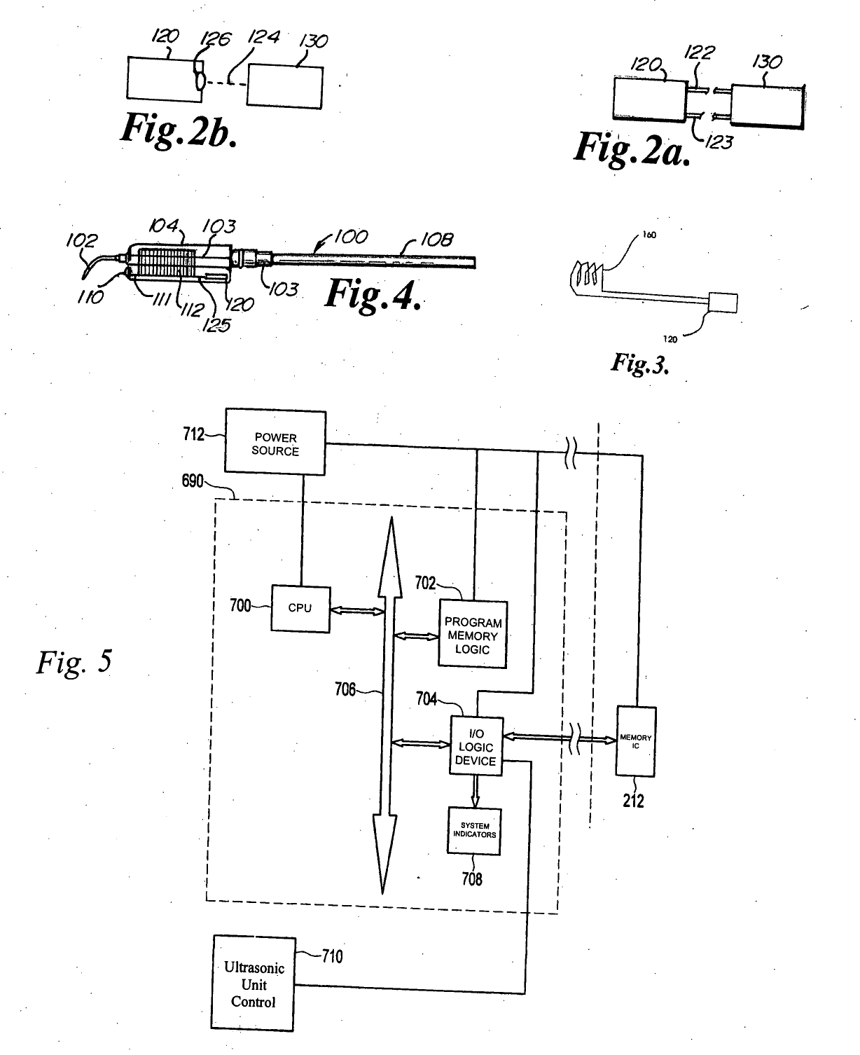

In one embodiment, the ultrasonic dental insert 100 includes a monitoring circuit 120, as shown in FIG. 2. The monitoring circuit 120 may generally include, for example, an integrated circuit (IC) chip (not specifically shown). The IC chip may be, for example, a memory chip, an electromechanical sensor and/or any other appropriate monitoring device. In general, the IC chip may monitor a characteristic(s) of the insert 100, such as its duration of use, usage frequency, power level, stroke amplitude, and/or any other appropriate characteristic. The monitoring circuit 120 may be disposed on or in the housing 104 of the insert 100. In some embodiments, the monitoring circuit 120 may be substantially self-contained within the housing 104 such that it may be isolated from outside contamination or conditions, such as the moist or wet environment during use of the insert 100, or the wet, high temperature environment of autoclave sterilization. In other embodiments, the monitoring system 130 or portions thereof, as shown in FIG. 2a and FIG. 2b, may be in the handpiece 200. In general, the monitoring circuit 120 may be disposed such that the IC chip may properly monitor a given characteristic of the insert 100. This may include, for example, being in close proximity to the tool tip 102 or connecting body 103 to monitor electromechanical characteristics during use.

The monitoring circuit 120 may be connected to a monitoring system 130, as shown in FIGS. 2a and 2b. The monitoring system 130 may generally be disposed on or in the ultrasonic unit 14 and it may also have portions disposed on or in the handpiece 200, as noted above. The monitoring system 130 may be, for example, part of the monitoring circuit 120 of the insert 100 or it may be a control or indicator system for the monitoring circuit 120.

The monitoring circuit 120 may be connected for communication to the system 130 by any appropriate system, which may include, but are not limited to, electrical conductors, such as electrical wires 122, 123 in FIG. 2a, magnetic or physical contacts, such as, for example, actuators (not shown), or wireless communication, such as, for example, radio frequency transmission (RF), infrared transmission, Bluetooth wireless, and/or any other appropriate system, as illustrated with wireless communication line 124 in FIG. 2b. The monitoring circuit 120 may include an antenna 126 to send and/or receive transmissions.

In general, the monitoring circuit 120 may be powered by any appropriate power source, such as, for example, a battery, a capacitor, a transducer, an external source and/or any other appropriate source.

In one embodiment, monitoring circuit 120 of FIGS. 2, 2a and 2b is a time monitoring circuit. The time monitoring circuit may record the usage time of an ultrasonic dental insert 100. The time monitoring circuit may include an integrated circuit (IC) chip 120 and monitoring system 130 which may be an electrical signal source. The electrical signal source 130 may supply the IC chip of the monitoring circuit 120 with a duration signal. The duration signal may be supplied by the electrical signal source 130 when the ultrasonic dental insert 100 is in use. The IC chip of the monitoring circuit 120 may then record the length of time of the signal and thus may record the duration of use of an ultrasonic dental insert 100. The IC chip of the monitoring circuit 120 may further generate a return signal which may indicate the total recorded time. The ultrasonic unit 14 may also include a notification or indication system for informing a user of the state of the insert 100, which may, for example, include a suggestion for replacing the insert.

In another embodiment, monitoring system 130 of the ultrasonic unit 14 may be a time monitoring circuit which may record the duration of use of the unit 14. In particular, the time monitoring circuit 130 may record the duration of a usage cycle (e.g. the time between activating the insert 100 and deactivating the insert 100). The time monitoring circuit 130 may then transmit the duration information to an IC chip of the monitoring circuit 120 on the insert 100, which may record an integrated time duration of the usage of insert 100 by summing the usage times transmitted by the time monitoring circuit 120.

In some embodiments, the IC chip of the monitoring circuit 120 may provide a predetermined maximum usage time that may limit the duration of use of the ultrasonic dental insert 100. The IC chip of the monitoring circuit 120 may, for example, generate a control signal which may prevent the usage of the ultrasonic dental insert 100 by an ultrasonic unit or handpiece when the maximum usage time has been reached, or it may cause the unit 14 to indicate that the insert 100 may need replacement via an at least one indicator 15, as shown in FIG. 1.

In another embodiment, the monitoring circuit 120 includes a sensor(s) which may detect electromechanical characteristics of the insert 100. Measured electromechanical characteristics may include, but are not limited to, power level, stroke amplitude, vibration frequency, and/or any other appropriate characteristic. Alternatively, the monitoring system 130 in the ultrasonic unit 14 may include a sensor(s).

In one embodiment, the ultrasonic dental unit 14 may include systems for storing established reference values for insert electromechanical characteristics and comparing them to the detected values from the insert 100. The unit 14 may then determine whether the insert 100 is performing within or outside a predetermined acceptable range of performance and may indicate via an at least one indicator 15 to a user the status of the insert 100. This detection may be performed on either a new or used insert 100.

In still another embodiment, the monitoring circuit 120 may include a coil 160, as shown in FIG. 3. The coil 160 may be disposed in proximity to the insert 100 and may in general be utilized to detect electrical characteristics of the insert 100. The coil 160 may, for example, exhibit an electric current in response to the electromagnetic field of the coil in the handpiece 200 and/or to the ultrasonic vibrations of ferromagnetic components of the insert 100, which may include the tool tip 102 and/or the connecting body 103. The electric current in the coil 160 may be analyzed by the monitoring circuit 120 and/or the monitoring system 130 of the unit 14 to determine electrical characteristics of the insert 100. The electric current may also power the monitoring circuit 120.

In another aspect, the monitoring circuit 120 of the insert 100 may be externally powered. Ultrasonic inserts are typically autoclaved for sterilization and the harsh environment of the autoclave may be detrimental to an internal power source, such as a battery. The monitoring circuit 120 of the insert 100 may, for example, draw power from the ultrasonic unit 14 via electrical conductors 122, 123, as shown in FIG. 2a.

In some embodiments, the monitoring circuit 120 may be wireless and may be externally powered by a wireless power source. A wireless power source may include, for example, an electromagnetic field. A wireless monitoring circuit 120 may generally include an antenna 126, as shown in FIG. 2b. The antenna 126 may be utilized for transmitting and/or receiving communication signals with a monitoring system 130. The antenna 126 may further be utilized to power the wireless monitoring circuit 120 by converting an electromagnetic field, such as a wireless communication signal, into electric current.

In one embodiment, a coil 160 may be utilized as an antenna and a power source, as described above in regard to FIG. 3.

In another embodiment, the monitoring circuit 120 may include an energy dissipating system. IC chips may be subject to overpowering and/or electric shorting from an excess of electric current. This may be particularly problematic in systems such as IC chips that are wirelessly powered by antennas and/or coils. An energy dissipating system may be included to consume at least a portion of the electric current that would be provided to a monitoring circuit 120. This may aid in preventing overpowering and/or shorting of components of the monitoring circuit, such as, for example, an IC chip. An energy dissipating system may include, but is not limited to, resistors, inductors, capacitors, combinations thereof, and/or any other appropriate system.

In still another embodiment, the insert 100 includes a light source 110, as shown in FIG. 4. The light source 110 may share a power source with a monitoring circuit 120 and may further act as an energy dissipating system by consuming electric current and converting the energy into light. The light source 110 may in general be disposed on the insert 100 such that it may direct light onto the field of work. In an exemplary embodiment, a light source 110 may be located proximal to the tool tip 102, as shown in FIG. 4.

In one aspect, the power source may be, for example, a coil 112. The coil 112 may draw power in a manner similar or identical to the coil 160 discussed above and may provide power to the light source 110 and the monitoring circuit 120 via conductors 111, 125, respectively.

In another aspect, the light source 102 is energized by the already available ultrasonic vibrational energy such that an additional source of energy is not needed. By way of example, a transducer such as and/or including, an illumination energy coil, is provided and attached to the light source such that the light source is energized using vibrational energy converted by the transducer. By way of example, a first transducer is used to generate ultrasonic vibrations. This causes the connecting body to move rapidly to generate an electromagnetic field during operation of the insert. As the connecting body of the dental insert moves, an alternating current (ac) voltage is generated in the illumination energy coil, which is connected in series with the light source (e.g., light emitting diode (LED)) to provide energy for light emission. In other embodiments, any other suitable transducer for converting vibrational energy to energy for light emission may be used. The word “light source” as used herein may include one or more than one light source(s).

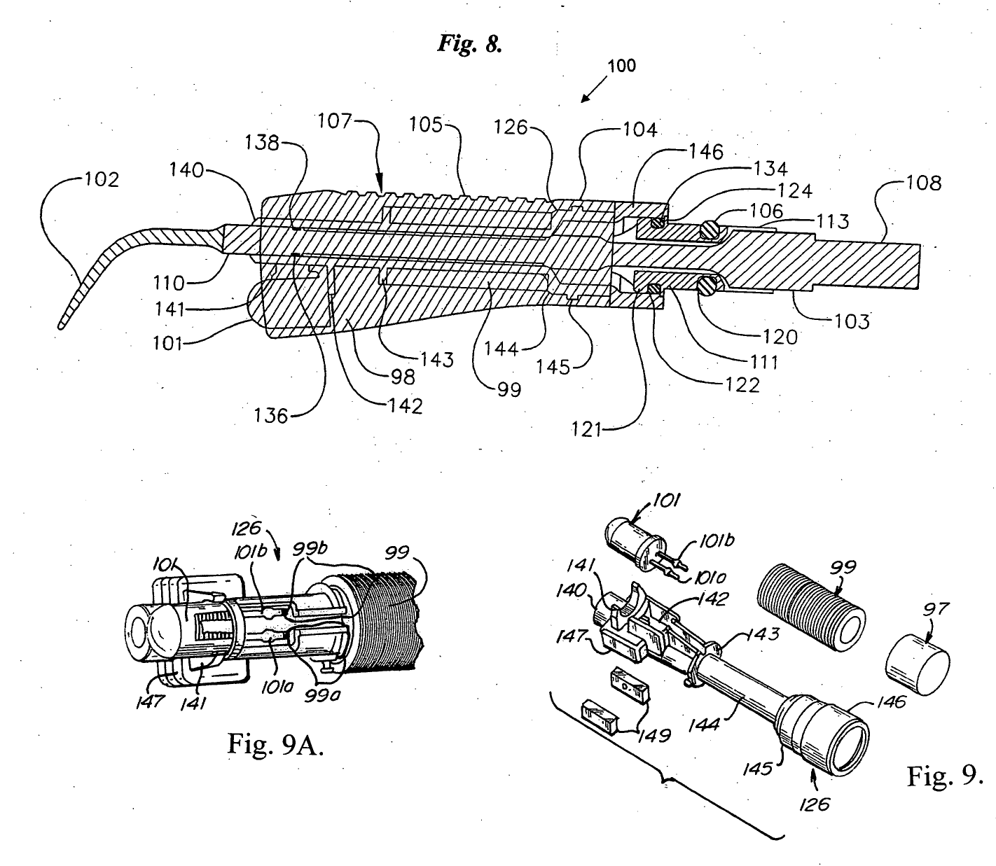

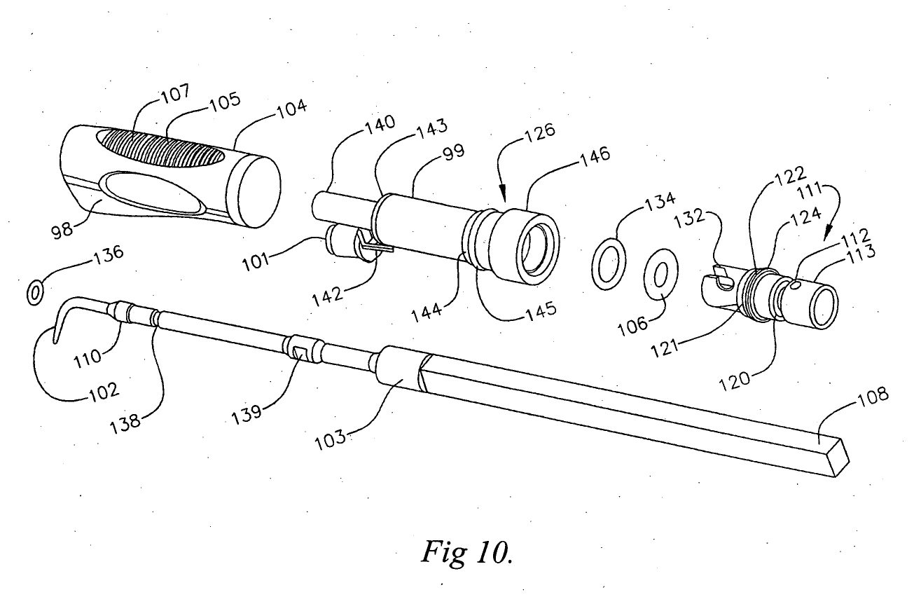

When the power for powering the light source is disposed on the insert 100, for example, proximate to the connecting body 103, which generates a voltage signal in response to movement of a portion of the connecting body 103 according to the ultrasonic vibrations, as exemplified in FIGS. 8 and 9. In FIG. 8, the connecting body 103 is also used to generate voltage in an illumination energy coil 99, as shown, surrounding at least a portion of the connecting body 103, the connecting body 103 is, for example, made of a material that has magnetic permeability, and further for example, good magnetic permeability. By way of example, 17-4 PH stainless steel, and 420 stainless steel, while suitable for transmitting ultrasonic vibrations, are also mildly magnetic. Therefore, the connecting body 103 formed from 17-4 PH stainless steel may generate an ac voltage on the illumination energy coil 99 by moving rapidly (e.g., 25 kHz or faster) within the illumination energy coil 99, which is mounted on an illumination energy bobbin 126. While only a cross-section of the illumination energy bobbin 126 is shown in FIG. 8, the illumination energy bobbin 126 may envelop much of the connecting body 103 in the described embodiment as will be discussed in reference to FIG. 10.

Referring now to FIGS. 8 and 10, the connecting body 103 may also have formed thereon a circular groove 138 near its distal end. An O-ring 136 is seated in the groove 138. When the illumination energy bobbin 126 is mounted on the connecting body 103, the O-ring 136 provides a seal between the connecting body 103 and the illumination energy bobbin 126 so as to prevent undesired fluid leakage.

The illumination energy bobbin 126 may be formed as one-piece, and may be slid onto and snap/pressure fit to the connecting body and/or the retaining ring 111.

The retaining ring 111 has a generally cylindrical shape, and has formed thereon a connecting portion 113, which has a generally cylindrical cavity formed therein for receiving a corresponding portion of the connecting body 103, as is shown in FIG. 8, in a force-fit relationship, or any other types of connections such as threaded connections, bayonet connections, and others. The retaining ring 111 is fixedly attached (e.g., snapped on) to the connecting body 103 such that it neither rotates nor moves laterally along the axis of the connecting body 103 during use.

The retaining ring 111 has formed thereon, adjacent to the connecting portion 113, a circular groove 120 for seating the external O-ring 106.

At the distal end, the retaining ring 111 has formed thereon a pair of gripping elements 132 that face each other. Each gripping element has an end portion that protrudes inwardly toward the end portion of the other gripping element. The connecting body 103 has a pair of indentations 139 formed thereon for receiving the protruding end portions of the gripping elements such that the gripping elements 132 are snapped into the indentations 139. Thus engaged, the retaining ring 111 of the illustrated embodiment is locked to the connecting body 103, and neither rotates nor moves laterally with respect to the same. The retaining ring 111 has also formed thereon circular flanges 121, 124 and a circular groove 122. The circular groove 122 is for seating an O-ring 134.

In other embodiments, the retaining ring 111 may not be present.

More details of the retaining ring may be found in U.S. publication no. 2004/0126736 A1, entitled “Ultrasonic Dental Insert Having A Hand Grip Fitted To A Retaining Ring”, the content of which is hereby incorporated by reference.

In a further aspect, the dental insert and/or handpiece includes a magnetic material or a magnetic source in close proximity for initiating, re-establishing, increasing and/or maintaining the brightness of the output light from the light source when in use.

Surprisingly, the presence of the magnetic material can increase the brightness of the light source to an extent that it render the location of mounting of the illumination bobbin 126 irrelevant, thus increasing the flexibility and robustness of manufacturing.

It can be seen in FIGS. 8 and 10 that the illumination energy bobbin 126 may have formed thereon, for example, a bracket 141 and a seat 142 for mounting the LED 101 thereon. Further, the illumination energy bobbin 126 has formed thereon a flange 143 and a generally cylindrical chamber 144, between which the illumination energy coil 99 is mounted. The generally cylindrical chamber 144 has formed thereon a flange 145. The illumination energy bobbin 126 also includes a ring section 146 attached to the chamber 144. The ring section 146 abuts the flange 121 of the retaining ring 111 when the ultrasonic dental insert 100 has been assembled.

FIG. 9 illustrates an exemplary embodiment of the illumination energy bobbin 126 of FIG. 10, showing the possible location of the magnetic material or source 400. As seen in the exploded view in FIG. 9, the illumination energy bobbin 126 has formed thereon away from the ring section 146 a tube portion 140 which envelops the portion of the connecting body 103 near the tip 102 (not shown). In the described embodiment, the fluid enters the illumination energy bobbin 126 through the ring section 146, and exits the illumination energy bobbin 126 through the tube portion 140. The illumination energy coil 99 interfaces with the pins or electrodes 101a, 101b of the light source 101 through the ends of the coil 99a, 99b respectively, as illustrated in FIG. 9A, such that electrical energy may be passed from the illumination energy coil 99 to the light source 101. The illumination energy coil 99 may further have tape or other holding material 97, for example, disposed over at least a portion of the coil to maintain proper positioning and to prevent unwinding of the coil 99.

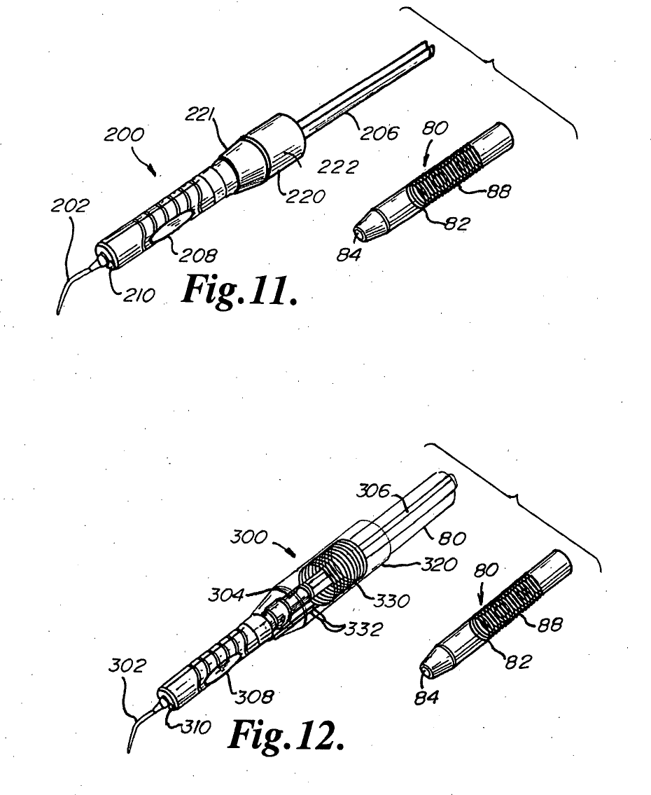

In yet another aspect, an ultrasonic dental insert includes a sheath 220. FIG. 11 illustrates an embodiment of an insert 200 that includes a sheath 220. The sheath 220 may be formed such that it may cover at least part of a handpiece housing 82 when inserted into a handpiece 80. In general, the sheath 220 may serve as a barrier such that it may reduce cross-contamination to and from the patient's mouth. The insert 200 may, for example, be sterilized prior to use by methods such as autoclaving, alcohol sterilization, and/or any other appropriate method such that when the sheath covers the handpiece 80, it may provide a sterile surface that may be inserted into the patient's mouth, as noted before. The ultrasonic dental tool may then be used without sterilizing of the handpiece 80. The sheath 220 may also help to prevent contaminants from one patient's mouth from being transferred to another patient or to the work area by the handpiece.

In one aspect, the illumination energy coil 330 may be supported by a sheath 320 integral to the ultrasonic dental insert 300, as shown in FIG. 12. In one embodiment, the illumination energy coil 330 may be contained within the sheath 320, which may position the coil 330 for inductive coupling to the primary coil 88 of the handpiece 80 when the insert 300 is inserted into the handpiece 80. In another embodiment, the coil 330 may be disposed on the inner surface of the sheath 320. The sheath 320 may, for example, be overmolded over the coil 330. The sheath 320 may also be partially molded onto the insert 300 and the coil 330 may then be wound onto the partially molded sheath 320. The remainder of the sheath 320 may then be overmolded over the coil 330 such that it may be embedded in the material of the sheath 320. In general, the coil 330 may be disposed between the handpiece 80 and at least a portion of the sheath 320 and/or otherwise supported by the sheath 320.

In another embodiment, or in addition to the monitoring mechanism, the invention may include a control mechanism to inhibit the use of an insert on additional patients after it has reached the predetermined maximum usage time. One aspect of the control mechanism is that the inhibition occurs during the attachment process of the insert to the handpiece.

As noted above, one embodiment of the invention effects control of the insert usage by including a recording medium in the insert 100, and a signal generating device elsewhere in the ultrasonic unit 14. In one aspect, the invention includes receipt by the recording medium of a signal from the signal generating device, and recording of a record of the recording medium corresponding to the received signal to produce a substantially permanent signal record. In another aspect of the invention, the substantially permanent signal record is read by a medium reading device and a condition of use of the particular insert containing the recording medium is ascertained. Based on the condition of use indicated by the record, as read, a control device external to the insert serves to allow or inhibit activation of the unit 14.

In one embodiment of the invention, the signal generating and record reading devices may be located within the handpiece 200. In another embodiment of the invention, one or more of the signal generating and record reading devices are located external to the handpiece 200.

In one embodiment of the invention, the signal from the signal generating source may be received at the recording medium by way of an electromechanical coupling. In another embodiment of the invention, the signal from the signal generating source may be received at the recording medium by way of an optical communication channel. In a still further embodiment of the invention, the signal from the signal generating source is received at the recording medium by way of a mechanical communication channel, an acoustic communication channel, a radiofrequency communication channel, or any other communication medium appropriate the particular invention embodiment.

FIG. 5 is a block diagram of an embodiment of the ultrasonic unit control system 690 of the ultrasonic dental tool 10 of the present invention. In one embodiment, the microelectronics of the control system 690 are located in the ultrasonic unit 14, as illustrated in FIG. 1. In another embodiment, the microelectronics of the control system 690 are located in the handpiece 200. Other locations for the control system electronics are possible within the scope of the invention.

The control system 690 includes a CPU 700, program memory logic 702, an I/O logic device 704, a data bus 706 and system indicators 708. The CPU 700, program memory logic 702, and the I/O logic device 704 are connected to the data bus 706. The I/O logic device 704 is further connected to system indicators 708. In one embodiment of the invention, the I/O logic device 704 further includes device drivers. The I/O logic device 704 is further connected to the memory integrated circuit 212, which may be disposed on an ultrasonic insert 100. Ultrasonic unit controls 710 are connected to the I/O device 704. A power source 712 provides power to the CPU 700, program memory logic 702, the I/O logic device 704 and the memory integrated circuit 212.

The CPU 700, program memory logic 702 and the I/O logic device 704 are for example, microelectronic devices, located in the ultrasonic unit 14. In an alternative embodiment of the invention, the ultrasonic unit controls 710 and power source 712 are also located in the ultrasonic unit 14. In an alternative embodiment of the invention, the CPU 700, program memory logic 702, I/O logic device 704, ultrasonic unit controls 710, and power 712 are, for example, located in the handpiece 200. The ultrasonic unit controls 710 are, for example, at least one transistor device or electronic or electromechanical relay device for controlling the on/off function of the ultrasonic unit 14. The system indicators 708 are, for example, the lighted indicators on the ultrasonic unit 14 or, for example, the handpiece 200.

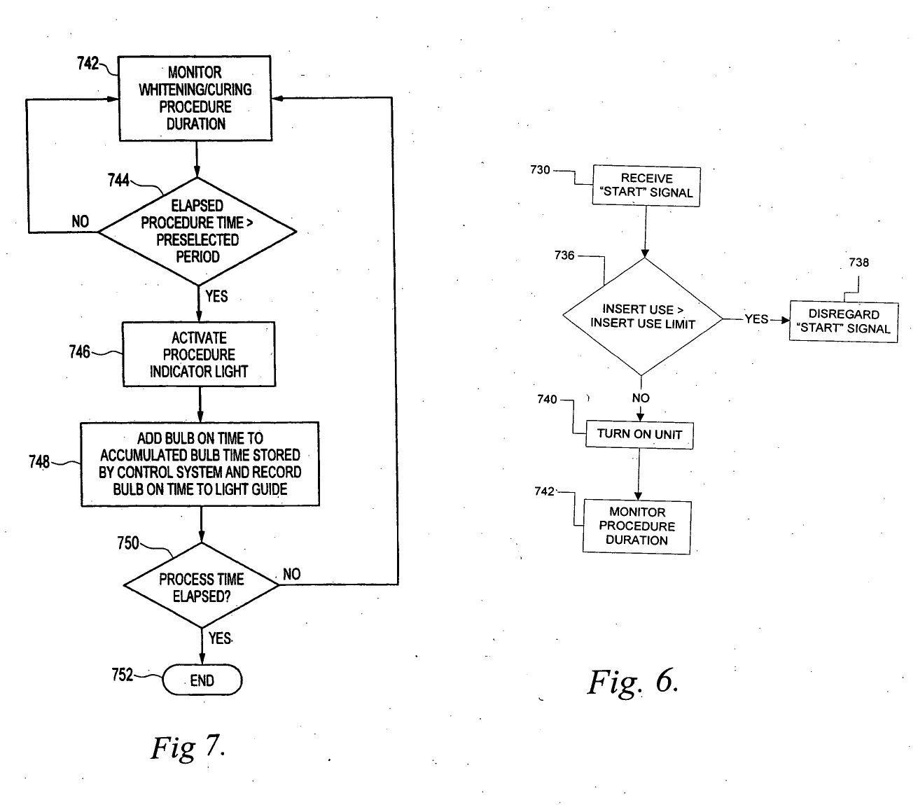

FIG. 6 is a flow chart showing one embodiment of the start process of the ultrasonic unit 14 that is executed by the control system 690 illustrated in FIG. 5.

At step 730, the control system 690 receives a “start” signal from the ultrasonic unit controls 710. According to one embodiment of the invention, the duration between the start of a procedure and the procedure time limit is divided by the control system 690 into preselected time intervals.

At step 736, the control system 690 determines whether the ultrasonic insert usage has exceeded the ultrasonic insert limit stored in the control system 690. The ultrasonic insert usage limit may be predetermined based on any appropriate factor or combination of factors, which may include, but are is not limited to, estimated usage life, average usage life, and/or any other appropriate factor or combinations thereof. The control system 690, as mentioned above in step 732, monitors the time that the ultrasonic unit is on and active (delivering energy to the handpiece). The control system 690 writes the amount of time that the ultrasonic unit has been on since the beginning of a treatment procedure to a recording device on the ultrasonic insert. The recording device is, for example, a memory integrated circuit 212, such as described above. When the “start” signal is received from the ultrasonic unit controls 710, the control system 690 compares the ultrasonic unit “on” time stored on the recording device in the ultrasonic insert with the ultrasonic insert use limit stored by the control system 690. If the ultrasonic insert use limit has been exceeded, the control system 690 proceeds to step 738. If the ultrasonic insert use limit has not been exceeded, the control system 690 proceeds to step 740.

At step 738, the control system 690 disregards the “start” signal with regard to turning the ultrasonic unit on. That is, the control system 690 does not allow the ultrasonic unit to operate if the ultrasonic insert lifetime has expired. This portion of the control system 690 acts to prevent the ultrasonic insert from being reused. The ultrasonic insert may be intended to be used for a finite period before being discarded and replaced.

At step 740, the control system 690 starts the ultrasonic unit (provides power to the handpiece).

At step 742, the control system 690 monitors the treatment procedure time. In this step, the control system 690 monitors the time that the ultrasonic unit is on. The monitoring procedure of the control system 690 is described below with regard to FIG. 7.

FIG. 7 is a flow chart showing one embodiment of the monitoring process of the ultrasonic dental tool 10 that is executed by the control system 690 illustrated in FIG. 5.

At step 742, the control system 690 monitors the duration of the treatment, that is, the control system 690 monitors the ultrasonic unit “on” time.

At step 744, the control system 690 determines whether the elapsed procedure time has exceeded a preselected time period. Here, the preselected time period is some portion of the overall treatment time such as one quarter of the total treatment time. If the elapsed procedure time has not exceeded the preselected time period, the control system 690 continues to monitor the treatment duration (step 742). If the elapsed procedure time does exceed the preselected time period, then the control system 690 proceeds to step 746.

At step 746, the control system 690 activates a procedure indicator, for example a lighted indicator on the ultrasonic unit 14 or handpiece 200. In one embodiment, the control system 690 activates another lighted indicator as each treatment portion time elapses so that if, for example, there are four lighted indicators, all four are lit at the end of the treatment procedure. In another embodiment, a single lighted indicator may be used to indicate the time progression of the treatment. In this embodiment, the light indicator may have varying flash rates to indicate the how much time has elapsed since the start of treatment. The control system 690 then proceeds to step 748.

At step 748, the control system 690 adds the time that the ultrasonic unit has been on to the accumulated time that the control system 690 has stored from previous treatment procedures, if any. The control system 690 also writes the time that the ultrasonic unit has been on to the ultrasonic insert recording device, such as the memory integrated circuit 212. The control system 690 then proceeds to step 750.

At step 750, the control system 690 determines whether the overall process time has elapsed. The overall process time is the time duration of the treatment. If the overall process time has not elapsed, the control system 690 returns to step 742, monitoring the treatment duration. If the overall process time has elapsed, the control system 690 proceeds to step 752.

At step 752, the duration of the treatment has elapsed and the control system 690 turns off the ultrasonic unit.

In another exemplary embodiment, a control mechanism may be provided to inhibit the use of an insert 100 when the insert does not have an identification marker that is recognized by the unit 14 and/or handpiece 200. One aspect of the control mechanism is that the inhibition occurs during the attachment process of the insert 100 to the handpiece 200. In one embodiment, the control mechanism inhibits the operation of the unit 14. In another embodiment, the control mechanism inhibits the operation of the handpiece 200.

According to one embodiment, the unit 14 and/or handpiece 200 includes a recognizer that may be programmed to recognize or operate an inert 100 having a particular identification marker. According to another embodiment, the unit 14 and/or handpiece 200 may include a chip with a recognizing mechanism that activates an insert 100 only if only certain features are on the insert to be recognized. Such markers may be incorporated into the chip or be a part for completing an electrical circuit so that without it, the circuit remains open. In general, the markers may not be removable once incorporated.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. An ultrasonic dental tool comprising:
a dental insert comprising a transducer, a connecting body having a tip thereon and at least a portion of a monitoring mechanism;
a handpiece having a substantially hollow body for receiving said dental insert; and
an ultrasonic unit for supplying power to said handpiece;
wherein said monitoring mechanism monitors at least one electromechanical characteristic or duration of use of said dental insert and communicates said characteristic or duration to said ultrasonic unit for indication to a user.

2. The ultrasonic dental tool of claim 1 wherein said monitoring mechanism comprises at least one integrated circuit chip.

3. The ultrasonic dental tool of claim 1 wherein said at least a portion of said monitoring mechanism of said dental insert communicates with said ultrasonic unit via a wired or wireless connection.

4. The ultrasonic dental tool of claim 3 wherein said wireless connection is effected by radio frequency transmission or infrared transmission.

5. The ultrasonic dental tool of claim 2 wherein said at least one integrated circuit chip is a memory chip for storing duration of use information of said dental insert.

6. The ultrasonic dental tool of claim 2 wherein said at least one integrated circuit chip is disposed on or in said dental insert.

7. The ultrasonic dental tool of claim 5 wherein said ultrasonic unit further comprises an electric signal source for transmitting a duration signal to said memory chip.

8. The ultrasonic dental tool of claim 1 wherein said ultrasonic unit further comprises at least one indicator, said ultrasonic unit indicates said at least one electromechanical characteristic or duration of said dental insert to a user via said indicator.

9. The ultrasonic dental tool of claim 1 wherein said at least a portion of said monitoring mechanism resides on said ultrasonic unit or handpiece.

10. The ultrasonic dental tool of claim 1 wherein said monitoring system further controls activation of said ultrasonic unit.

11. An ultrasonic dental tool comprising:
a dental insert comprising a transducer, a connecting body having a tip thereon; and at least a portion of a control mechanism, said control mechanism comprising an identification marker and recognizer;
a handpiece having a substantially hollow body for receiving said dental insert;
an ultrasonic unit having at least one indicator, said ultrasonic unit is adapted for supplying power to said handpiece;
wherein said control mechanism controls activation of said dental insert, handpiece or ultrasonic unit.

12. The ultrasonic dental tool of claim 11 wherein said at least a portion of said control mechanism resides on said ultrasonic unit.

13. The ultrasonic dental tool of claim 11 wherein said identification marker resides in said dental insert.

14. The ultrasonic dental tool of claim 11 wherein said recognizer resides in said handpiece or ultrasonic unit.

15. The ultrasonic dental tool of claim 11 wherein said control mechanism of said dental insert communicates with said ultrasonic unit or handpiece via a wired or wireless connection.

16. The ultrasonic dental tool of claim 15 wherein said wireless connection is effected by radio frequency transmission or infrared transmission.

17. The ultrasonic dental tool of claim 11 wherein said control mechanism comprises at least one integrated circuit chip.

18. The ultrasonic dental tool of claim 17 wherein said at least one integrated circuit chip comprises a memory chip for storing duration of use information of said dental insert.

19. An ultrasonic dental tool comprising:
a dental insert comprising a transducer, a connecting body having a tip thereon; and at least a portion of a monitoring system, said monitoring system comprising at least one integrated circuit chip;
a handpiece having a substantially hollow body for receiving said dental insert; and
an ultrasonic unit having at least one indicator, said ultrasonic unit is adapted for supplying power to said handpiece;
wherein said monitoring system controls the use of said dental insert, handpiece or ultrasonic unit and communicates the use to a user via said indicator.

20. The ultrasonic dental tool of claim 19 wherein said portion of said monitoring system of said dental insert communicates with said ultrasonic unit via a wired or wireless connection.

21. The ultrasonic dental tool of claim 19 wherein said monitoring system monitors at least one electromechanical characteristic or duration of use of said dental insert.

22. The ultrasonic dental tool of claim 19 wherein said monitoring system further controls activation of said handpiece, dental insert or ultrasonic unit via an identification maker and recognizer.

23. The ultrasonic dental tool of claim 19 wherein said at least one integrated circuit chip is a memory chip for storing duration of use information of said dental insert.

24. The ultrasonic dental tool of claim 23 wherein said ultrasonic unit further comprises an electric signal source for transmitting a duration signal to said memory chip.
